(19) United States
(12) Patent Application Publication
(10) Pub. No.: US 2014/0095207 A1
(43) Pub. Date: Apr. 3, 2014

(54) SYSTEMS AND METHODS FOR DISPLAYING PATIENT INFORMATION ON A MOBILE SYSTEM

(71) Applicant: Allen Technologies, Inc., Austin, TX (US)

(72) Inventors: Sanjeev Dhir, Austin, TX (US); Chandrasekhara R. Budda, Grapevine, TX (US); David Potter, Austin, TX (US); Roy Womack, San Angelo, TX (US); Satwinder Kahlon, Austin, TX (US); Jerry Folsom, The Hills, TX (US)

(73) Assignee: Allen Technologies, Inc., Austin, TX (US)

(21) Appl. No.: 14/042,648

(22) Filed: Sep. 30, 2013

Related U.S. Application Data
(60) Provisional application No. 61/707,719, filed on Sep. 28, 2012.

(51) Int. Cl. G06F 19/00

(52) U.S. Cl. CPC G06F 19/322
USPC 705/3

(57) ABSTRACT

A computer-implemented method for displaying information to a patient in a hospital setting. A mobile device collects credentials from a patient. A request for a server to authenticate the patient based on the credentials collected from the patient, and upon authenticating the patient, to reply with patient information requested by the patient is generated. The collected credentials and the request are transmitted to the server. The requested patient information is received by the mobile device.

### RELATED APPLICATIONS

This application claims priority to U.S. Application No. 61/707,719, entitled SYSTEMS AND METHODS FOR DISPLAYING PATIENT INFORMATION ON A MOBILE DEVICE, and filed on Sep. 28, 2012, which is incorporated herein in its entirety by this reference.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The widespread use of computers has been accelerated by the increased use of computer networks, including the Internet.

Many businesses use one or more computer networks to communicate and share data between the various computers connected to the networks. The productivity and efficiency of employees often require human and computer interaction. Users of computer technologies continue to demand an increase in the efficiency of these technologies. Improving the efficiency of computer technologies is always desirable to anyone who uses and relies on computers.

Computing systems may be mobile so that users may carry these systems as they travel, shop, work, etc. Mobile computing devices, such as cellular telephones, have become increasingly popular among adults and teenagers (as well as, in some cases pre-teenagers). The mobile devices provide convenience and ease to locate information by providing capabilities to browse the Internet, send/receive emails and text messages, provide multi-media (music, movies, etc.). The constant access by individuals to computing systems has led to an incessant desire by consumers to access information. Consequently, there is a need for additional opportunities to obtain personal information in otherwise restricted areas.

### SUMMARY

According to at least one embodiment, a computer-implemented method to display medical information of a user is described. A mobile device collects credentials from a patient. A request for a server to authenticate the patient based on the credentials collected from the patient, and upon authenticating the patient, to reply with patient information requested by the patient may be generated. The collected credentials and the request may be transmitted to the server. The requested patient information may be received by the mobile device.

In one embodiment, the credentials include a hospital-provided patient identifier and a patient-provided identifier. A mobile device identifier associated with the mobile device may be transmitted with the credentials and request. The server may only send the requested information to the mobile device in response to receiving the unique mobile device identifier, the request, and the credentials. The hospital-provided patient identifier may be collected by scanning an optical machine-readable code on a hospital-provided wristband using a camera on the mobile device. The hospital-provided patient identifier may be collected by scanning a hospital-provided radio-frequency identifier (RFID) device. The hospital-provided patient identifier may be collected by scanning a hospital-provided near-field communications (NFC) device.

In some embodiments, the mobile device identifier may include a media access control (MAC) address of the mobile device. Prior to sending the request for patient information it may be verified, via the credentials and a mobile device identifier associated with the mobile device, that the mobile device is assigned to the patient. The request may include a request to receive, in addition to the patient information, at least one of audio and media data from the server.

A computing device configured to display information to a patient in a hospital setting is also described. The device may include a processor and memory in electronic communication with the processor. The memory may store instructions that may be executable by the processor to collect credentials from the patient, generate a request for a server to authenticate the patient based on the credentials collected from the patient, and upon authenticating the patient, to reply with patient information requested by the patient. The memory may store instructions that may be executable by the processor to transmit the collected credentials and the request to the server, and receive the requested patient information.

A computer-program product to display information to a patient in a hospital setting is also described. The computer-program product may include a non-transitory computer-readable medium that stores instructions. The instructions may be executable by the processor to collect credentials from the patient, generate a request for a server to authenticate the patient based on the credentials collected from the patient, and upon authenticating the patient, to reply with patient information requested by the patient. The memory may store instructions that may be executable by the processor to transmit the collected credentials and the request to the server, and receive the requested patient information.

Features from any of the above-mentioned embodiments may be used in combination with one another in accordance with the general principles described herein. These and other embodiments, features, and advantages may be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a data module;

FIG. 3 is an exemplary screenshot illustrating an example implementation of the present systems and methods;

FIG. 4 is another exemplary screenshot illustrating an example implementation of the present systems and methods;

FIG. 5 is another exemplary screenshot illustrating an example implementation of the present systems and methods;

FIG. 6 is another exemplary screenshot illustrating an example implementation of the present systems and methods;

FIG. 7 is another exemplary screenshot illustrating an example implementation of the present systems and methods;

FIG. 8 is a flow diagram illustrating one embodiment of a method for displaying information to a patient in a hospital setting;

FIG. 9 is a flow diagram illustrating one embodiment of a method for authenticating a patient to allow the patient to retrieve patient data; and

FIG. 10 depicts a block diagram of a computer system suitable for implementing the present systems and methods.

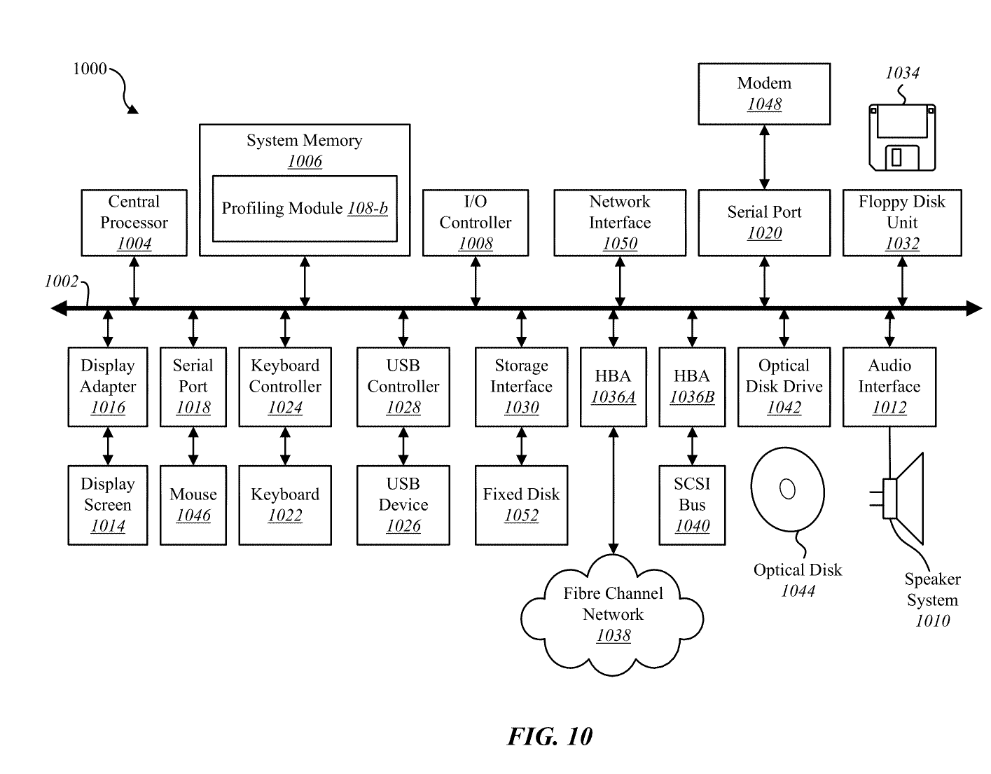

While the embodiments described herein are susceptible to various modifications and alternative forms, specific embodiments have been shown by way of example in the drawings and may be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The following description provides exemplary specifications and implementations of the present exemplary systems and methods. The exemplary systems and methods may be configured to control user entertainment devices including, but in no way limited to, audio visual systems, patient beds, and the like. According to one exemplary embodiment, the present systems and methods provide applications (“apps”) for conducting post-paid multi-tier transactions in a hospital setting.

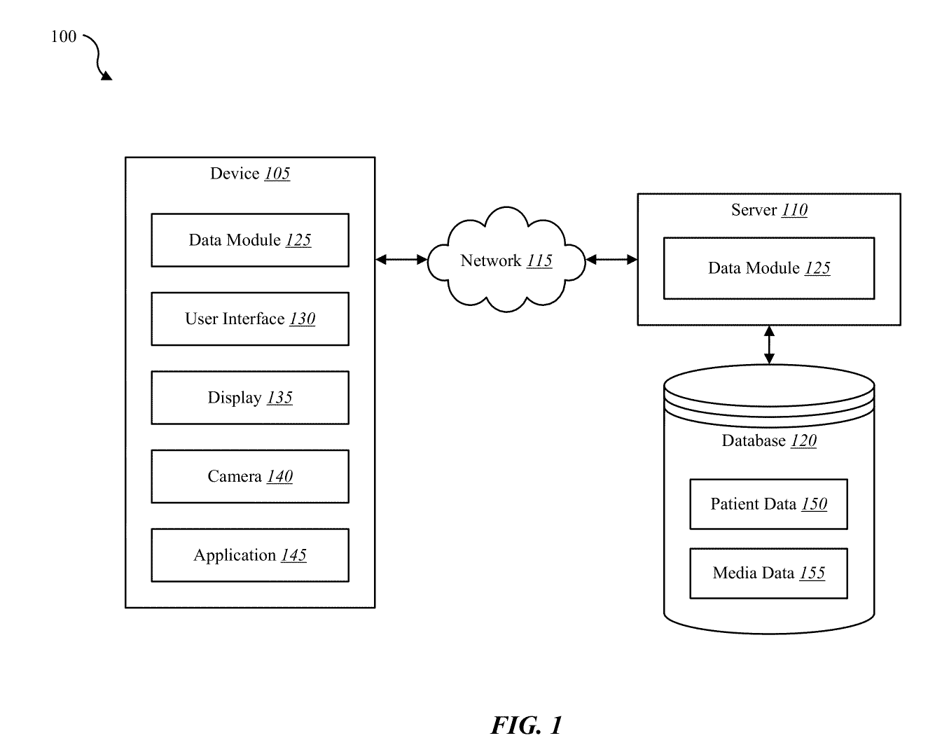

FIG. 1 is a block diagram illustrating one embodiment of an environment 100 in which the present systems and methods may be implemented. In some embodiments, the systems and methods described herein may be performed on a single device (e.g., device 105). For example, a data module 125 may be located on the device 105. Examples of devices 105 include mobile devices, smart phones, tablet computing devices, personal computing devices, computers, servers, televisions, set-top boxes, internet protocol TVs (IPTVs), etc. Device 105 may be a device located in a patient's room. Although one device is depicted in environment 100, device 105 may include two or more devices communicatively coupled (e.g., a mobile computing device in a patient's room communicatively connected to a set-top box and television set in the patient's room). The device 105 may be associated with the patient, the patient's room, the patient's bed, etc. In some embodiments, device 105 includes a computing device used by hospital staff and/or a system administrator.

In some embodiments, a device 105 may communicate with a server 110 via a network 115. Example of networks 115 include, local area networks (LAN), wide area networks (WAN), virtual private networks (VPN), wireless networks (using 802.11, for example), cellular networks (using 3G and/or LTE, for example), etc. In some configurations, the network 115 may include the internet. In some embodiments, network 115 may include a wireless network located in a hospital to which device 105 may connect while located in the hospital.

In some configurations, the device 105 may include a data module 125, a user interface 130, a display 135, a camera 140, and an application 145. In one example, the device 105 may be coupled to a server 110. The server may be coupled to a database 120. The database may include patient data 150 and media data 155 (e.g., music, TV shows, movies, games, etc.). In some configurations, the server 110 may serve patient data 150 and/or media data 155 to device 105. The device 105 may show the retrieved data on display 135.

In one embodiment, the data module 125 may enable a patient at a hospital to retrieve information about their health, about their health care, their vitals, their medications, and so forth (e.g., patient data 150). Additionally, or alternatively, data module 125 may allow the patient to retrieve media from the server 110. For example, a user in a hospital bed may request a TV show from server 110 via device 105. The user may watch on display 135 the TV show in a picture-in-picture window while simultaneously requesting and reviewing information related to the patient (e.g., patient data 150).

In some embodiments, application 145 may operate in conjunction with the data module 125. Application 145 may include one or more applications (“apps”) loaded on device 105. One or more of the “apps” loaded on device 105 may be accessed by the patient paying for a certain tier of service via data module 125. Further information about data module 125 is provided below.

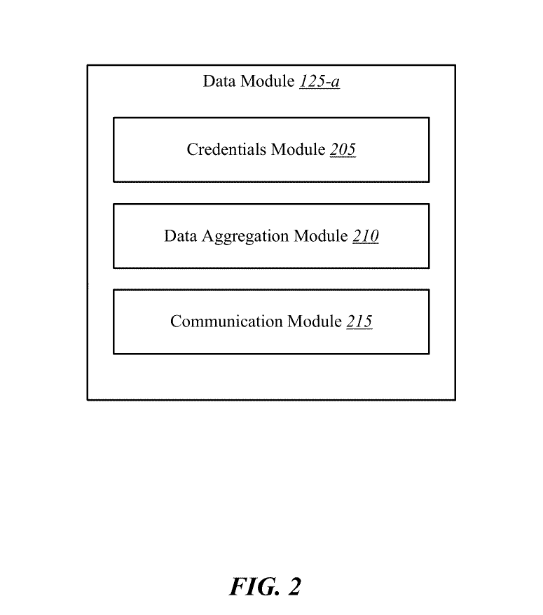

FIG. 2 is a block diagram illustrating one example of a data module 125-a. The data module 125-a may be one example of the data module 125 depicted in FIG. 1. As depicted, the data module 1258-a may include a credentials module 205, a data aggregation module 210, and a communication module 215.

In one embodiment, the data module 125-a may be configured to retrieving and displaying information to a patient in a hospital setting. In some embodiments, credential module 205 may collect credentials from a patient. The credentials may be used to authenticate the patient. Data aggregation module 210 may generate a request for patient information stored at a server. The request may include a request to receive, in addition to the patient information, at least one instance of multimedia data associated with the patient from the server application. Communication module 210 may transmit the collected credentials and the request to the server and receive the requested patient information to allow it to be displayed on a computing device (e.g., device 105). The credentials may include a hospital-provided patient identifier and a patient-provided identifier.

In some embodiments, communication module 210 may transmit, to the server, a mobile device identifier associated with the mobile device in addition to the credentials and request. The mobile device identifier may include a media access control (MAC) address of the mobile device. In some cases, the server may send the requested information to the mobile device only in response to receiving the unique mobile device identifier, the request, and the credentials.

In some embodiments, credential module 205 may collect the hospital-provided patient identifier by scanning an optical machine-readable code on a hospital-provided wristband using a camera on the mobile device. For example, the mobile device may include a camera (e.g., camera 140) allowing the patient to scan a code on a wristband worn by the patient. In some embodiments, credential module 205 may collect the hospital-provided patient identifier by scanning a hospital-provided radio-frequency identifier (RFID) device or by scanning a hospital-provided near-field communications (NFC) device.

In one embodiment, prior to sending the request for patient information, credential module 205 may verify, via the credentials and a mobile device identifier associated with the mobile device, that the mobile device is assigned to the patient. If the credential module 205 determine that the mobile device is not assigned to the patient, the credential module 205 may block the user from receiving information from the server.

In one embodiment, the mobile device may include an off-the-shelf tablet computing device. The off-the-shelf tablet computing device be transformed from an off-the-shelf system to a custom user interface via the operations of the data module 125, user interface 130, and/or application 145. Functions of the user interface 130 may include initialization (e.g., init—fetch pairing, display on system bar), placing the tablet in a lock down/kiosk mode (e.g., app installs, updates, etc., are unavailable to the patient/customer), requiring tablet logins for users and admin, providing authentication mechanisms (e.g., authentication for patient, staff, system admin, etc.), providing multiple modes (e.g., patient mode, staff mode, admin mode, etc.). Additionally, or alternatively, the custom user interface may include pairing of application program interfaces (APIs) (e.g., toolbar, app notify, etc.), identifying a system ID, providing a premium services API, providing control bar access, providing theft deterrence (e.g., software-based theft deterrence), providing platform image management (e.g., block photo taking ability, allow photo taking, allow user to edit and send photos the user takes, etc.), providing application management, providing a theme, pairing the tablet to a predetermined client and/or specified area/room, providing a system reset function, providing for secure tablet software updates, providing device lockdown (e.g., remote-enabled lockdown), and the like.

Accordingly, a patient may have to be authenticated before he or she is allowed to access their patient information on the tablet. Authentication may be a two-step process. First, patients may scan their wristband that may include a hospital-provided patient identifier. After this, patients may enter a user-provided user identifier (e.g., last four digits of their SSN) to verify their identity gain authorization to view their medical information on the tablet. The authentication process may verify that the patient is located in the correct room and has access to the correct tablet. Thus, in addition to authenticating the user by matching the user identifiers with a tablet ID, allowing the tablet to access specified content from the backend server, the tablet may also verify that the tablet is currently assigned to this user and/or room. For example, the tablet may verify that the tablet is located in the correct area of the hospital (e.g., floor, room, etc.). Additionally, or alternatively, the tablet may verify that that the user has not checked-out, but is still listed as being checked-in at the hospital. Based on this data, the system may allow the tablet to access predetermined portions of data from the backend, including entertainment data and/or patient data. The expiration and automatic logout time from portal may be a first value for patient data page (e.g., 3 minutes) and another value for the entertainment page (e.g., 10 minutes). Both time out values may be configurable.

A patient's tablet device may connect to the hospital network via the hospital's wireless connection. Access to the physical network may be controlled by a Network Access Control List, and only authorized tablets may be allowed on the hospital wireless network. The hospital may set up a separate service set identifier (SSID) for the management facility (backend). A virtual local area network (VLAN) may be configured at the hospital via the SSID. The VLAN may be uplinked to the management facility backend network. From the backend network, the dynamic host configuration protocol (DHCP) for the tablet devices may be served. This allows the creation of a media access control (MAC)-ID-based Access Control List at the DHCP, preventing a device that has wireless credentials, but incorrect MAC ID, from accessing the network. Data may be provided by backend services delivered via virtual private network (VPN) connections from the hospital server to the backend server. The network connection may use secure socket layer (SSL) for hypertext transfer protocol (HTTP) transactions. Theft deterrent software and mechanisms may also be incorporated (e.g., location-based alarms and notifications, device lock, data wipe, etc.).

The tablet apps handling sensitive data may require additional security. Protected Patient Data may only be accessed by providing necessary authentication credentials, such as providing a unique tablet identifier (e.g., MAC address), a hospital-provided patient identifier (e.g., Patient Armband ID), and a unique user-provided identifier (e.g., last four digits of a social security number, etc.). The tablet web app may transmit this info to the login service, and receive authorization, and create a persistent “token” of the patient ID currently using the tablet. The token may include an expiration. The expiration may be renewed automatically (e.g., in response to a user input, user detection, etc.).

Thus, system access and applications may implement a user login to authenticate the patient end user. When the user clicks on a user interface, the user may be asked to hold their wristband relative to a camera on the tablet. The system may display a square “focus area” as an indicator where the patient should hold the wristband in relation to the camera to enable the system to capture data from a optical machine-readable barcode on the wristband (e.g. UPC code, QR code, 3D barcode, high capacity color barcode, maxicode, holographic barcode, etc.). Once the system detects the barcode in the “focus area,” the system may capture an image of the barcode, store the image, and identity information used to authenticate the patient from the stored barcode image. In some embodiments, the system may read the hospital-provided patient identifier using BLUETOOTH® communications. In some embodiments, the system may read the hospital-provided patient identifier using a radio-frequency identifier (RFID) and/or near-field communication (NFC) device (e.g., an RFID tag embedded in the wristband). In some embodiments, the patient may enter the hospital-provided patient identifier manually. After the hospital-provided patient identifier is entered and received by the tablet device, an area may be displayed to capture the unique user-provided identifier (e.g., at least a portion of a patient's SSN, credit card information, driver license information, a user-provided pin and/or password, a biometric scan such as a fingerprint scan, and the like). With the unique user-provided ID and hospital-provided patient ID provided to, interpreted by, and accepted by the tablet device, the tablet device may provide the MAC address unique to the backend as well as both the unique user provided ID and hospital-provided patient ID to log the tablet in to the backend system. The system may use the MAC address of the tablet in all transactions as part of credentials. Thus, the system may authenticate the user with the server with these three pieces of information.

In some embodiments, Session Identifiers and security tokens may be used in transactions from tablet to backend. The application may time out after a configurable amount of idle time, expiring the session and security token, and requiring re-authentication before resuming. The tablet's standard browser may be used for authentication. All private data may be cleared when the browser is exited. Bookmarking functionality may be blocked. Questionable sites may also blocked. Network access may be managed by the backend administration. The access control lists may prevent unauthorized tablets or other devices from gaining access to the hospital wireless network.

In some embodiments, the tablet may query the backend for a unique system identifier (System ID) that may be used for pairing the tablet to a specific area, room, bed, user, etc. On start-up, the tablet may query a list of room/bed combinations from a backend web service. This list may include a per-element field indicating if a particular room/bed is currently paired with another tablet. This list may be used to populate a selection widget. In some embodiments, only one tablet may be paired with a room/bed at any given time. To ensure this is the case, the room/bed list presented as a pairing choice may be annotated to mark all currently paired room/beds as currently “paired.” If the user attempts to use a tablet not paired for the user's bed/room, a warning may be generated to notify the user that continuing to use the device may un-pair the current tablet if they continue before allowing the request to be submitted, disabling the ability to gain access to information from the backend. When the user submits a pairing choice (i.e. room/bed from the list), the web app sends the pairing request to a backend web service. This request includes the System ID and the room/bed. If this process completes successfully, the tablet may update the system bar with the room/bed the tablet is now paired with. In some embodiments, only hospital facility staff and the management admins are enabled to access the pairing process by placing the client in the System Configuration page of the tablet and requiring a password to access anything the settings.

Using the System ID, an application (“web app”) on the tablet may fetch the pairing information associated with the tablet from a backend web service. The pairing information returned from the backend may include room, bed, internet protocol (IP) address of an IPTV, etc. This information may be used to directly communicate with a web service running on the IPTV. The web service allows the web app to get the current power state of the TV, the current channel, and the active channel list. The web service also allows the web app to set the power state of the TV and the current channel.

Because the IPTV IP address may change, every web service call may include the room and bed returned from the backend pairing query. The IPTV verifies this information matches it before honoring requests and returns the appropriate success/failure status. If a web service call to the IPTV fails, the web app restarts and the pairing info is re-fetched from the backend.

In some embodiments, the system may provide services to patients in a tiered model. There may be two or more types of service or entertainment packages available to the patients, such as a free entertainment package (e.g., over the air channels, no internet, no apps, etc.), basic entertainment package (e.g., expanded channels, basic internet browsing, basic apps, etc.), and a premium entertainment package (e.g., premium channels, expanded internet browsing, expanded apps, etc.). In some embodiments, a customized app may wrap one or more other apps on the tablet. The custom app may checks if a selected app is in an unpaid-for tier and prompt the user to upgrade to the appropriate tier in order to gain access to the app. Once authorized, the user interface may jump to the app with no indication that it is wrapped. An application for a TV remote control may include a web GUI that makes API calls to control TV functions.

Patient data may be accessed from the hospital facility. The management facility may pull Patient Data from a healthcare information system and make it available to the management facility for access. The management system may pull patient records for each patient that is currently admitted and present in the hospital and put it on a server shared with the management facility. Each record may be in the form of an extensible markup language (XML) file. Each XML file may contain patient identity specific information for authentication and authorization like account number, discharge date, partial social security number or date of birth among other things. Each XML file may have data related to patient data related to various information sets, including “My Care Team,” “My Labs,” “My Allergies,” “My Diet,” “My Vitals,” and “My Medications,” for example. The XML file with patient data may be placed on a machine “share” at the hospital facility and may be accessible to the management facility. The management-facility-side of file storage system may pick up XML files from the share using Rsync/Unison. The file system on the management-facility-side (backend) may be in sync in near real time. That means, both file systems may have most current list of patient records. Then XML file may either be stored as XML type in the database or used directly to parse/read patient data. The management facility may have a XML file management system that may store patient file related information in a database table that may contain the Id, file name, Hospital Name, hospital-provided patient ID, a time stamp when the record was created or updated, XML type to store file data as XML, a flag that automatically marks content on the tablet for deletion when a patient is discharged, a time stamp when record was marked for deletion, and the like. After a patient is discharged or transferred out from a room, the tablet may be reset automatically to a “new” state, so all data including cached data is deleted. Any application settings, cached data, cookies, passwords, form data may be cleared. This clearing may occur after a configurable interval (on the backend server) has elapsed, after the patient has been discharged.

Tablet management may be modeled on set-top box (STB) management system. There may a new table that may hold tablet information. Tablet may be tethered virtually or paired to a valid, active installed STB. The backend and/or tablet may store a device ID, tablet manufacturer, tablet model, operating system information, MAC address, hospital information, room information, bed information, client user interface version information, pairing information including a pairing timestamp, and the like.

The backend system may include a server, which services may run in a tomcat and apache web server on Linux host. At least one device in the patient room may include an HTTP server. Administrative data may be maintained in databases, managed via web clients, and centrally managed. This data may be used as part of the service model for client apps. Backend Data may be processed and delivered to clients via a REST services implemented on the Linux hosts.

Patient information may be displayed as patient name with last name first and first name last. Patient information may be retrievable while patient is authenticated and logged on the system. Patient information may be retrieved from an XML snippet. An example XML snippet for patient information may include the following:

<idinfo>

<name>PTLNAME,PTFNAME REST</name>
<acctnumber>FN10001225563</acctnumber>
<unitnumber/>
<admdt>20120314</admdt>
<disdt/>
<location>NNSY</location>
<room>N12</room>
<bed>1</bed>
<ssn>8485</ssn>

</idinfo>

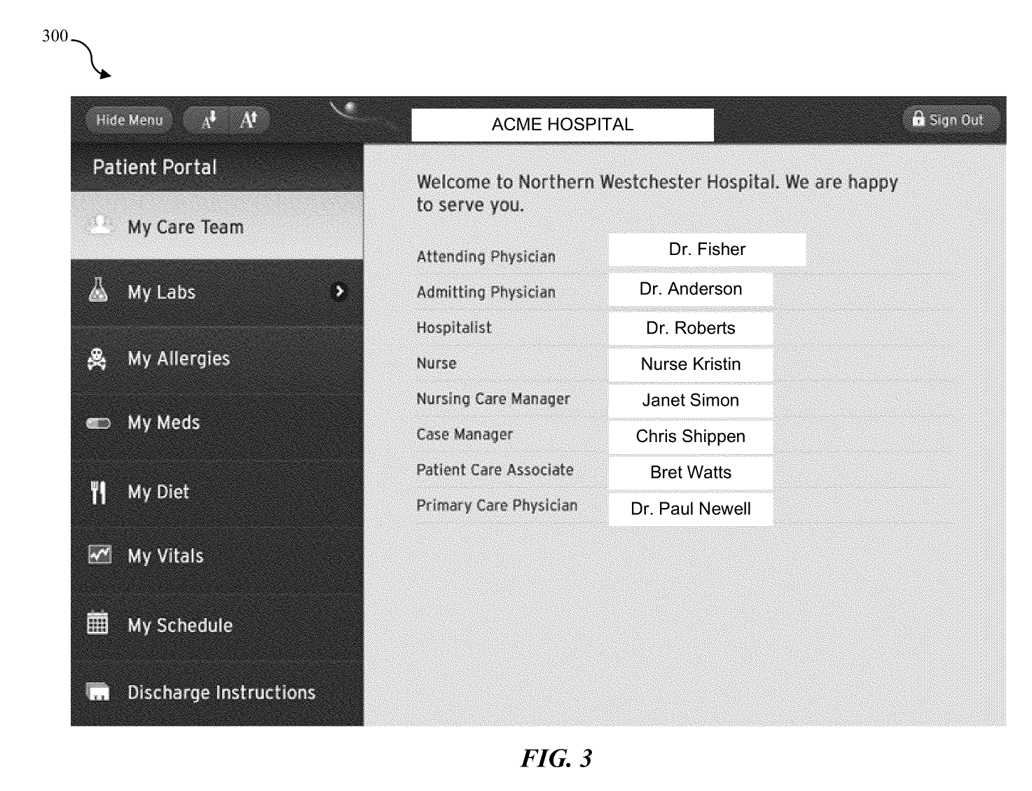

FIG. 3 shows an exemplary screenshot 300 illustrating an example implementation of the present systems and methods. Selecting a care team section from a patient info menu (e.g., “My Care Team”) may display information about members of the medical team that are taking care of patient while in hospital. It may include fields such as attending doctor, admitting doctor, hospitalist, nurse, nursing care manager, case manager, patient care associate, primary care physician, etc. The my care team data may be retrieved from an XML snippet.

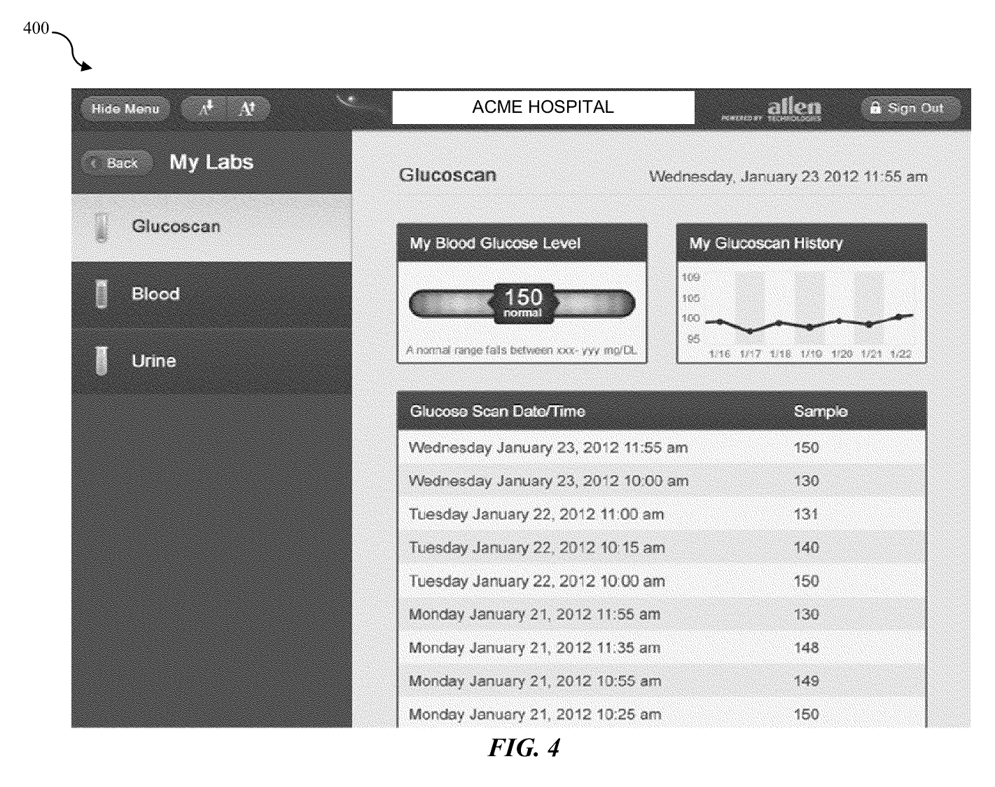

FIG. 4 is another exemplary screenshot 400 illustrating an example implementation of the present systems and methods. Selecting a lab work section from a patient info menu (e.g., “My Labs”) may present the data from the lab results of samples collected from the patient. For example, glucose scans results may be displayed under the My Labs section. My Labs info may include date and time when collected, blood glucose, normal range indicators, flags, table data, chart data, etc. My Labs data may be retrieved from an XML snippet. Similarly, selecting an allergies section from a patient info menu (e.g., “My Allergies”) may present the data from a patient allergies page, listing all the substances to which a patient is allergic. My Allergies data may be retrieved from an XML snippet

Selecting a diet section from a patient info menu (e.g., “My Diet”) may show the diets on which a patient is ordered to eat. There may be link to the menu options for the patient. The data items for My Diet section may include starting date, ending date, term or length of diet (e.g., 6 months, 12 months, life), diet type, recommended diet, description, one or more links to a menu page including options for breakfast, lunch, and dinner items that can be ordered by the patient from the patient's room. The My Diet data may be retrieved from an XML snippet

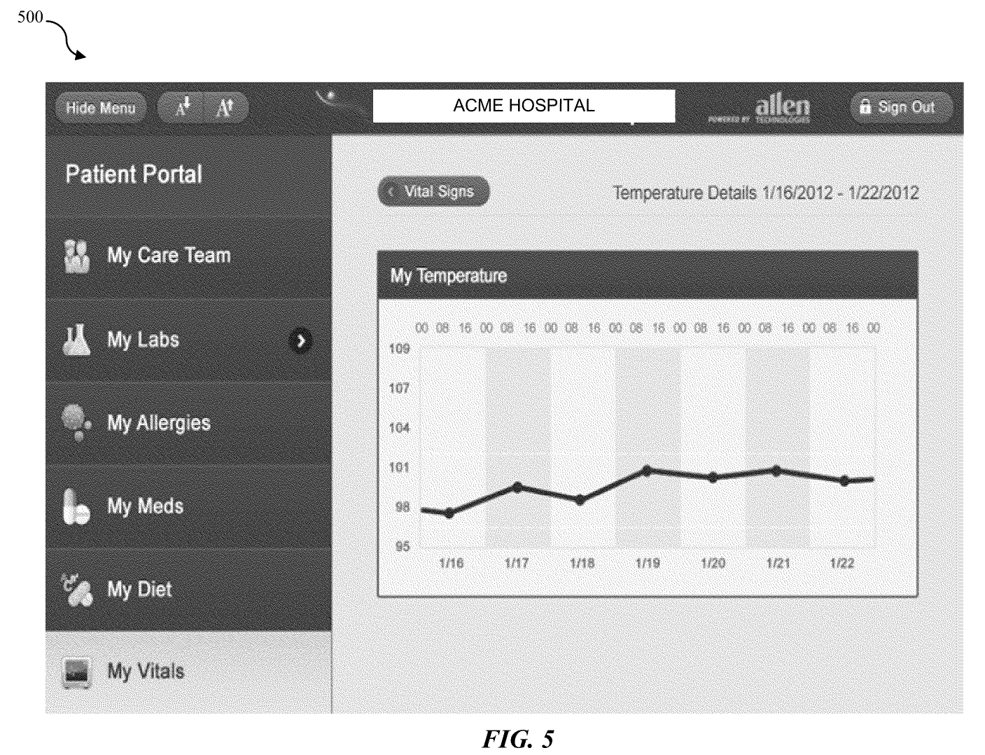

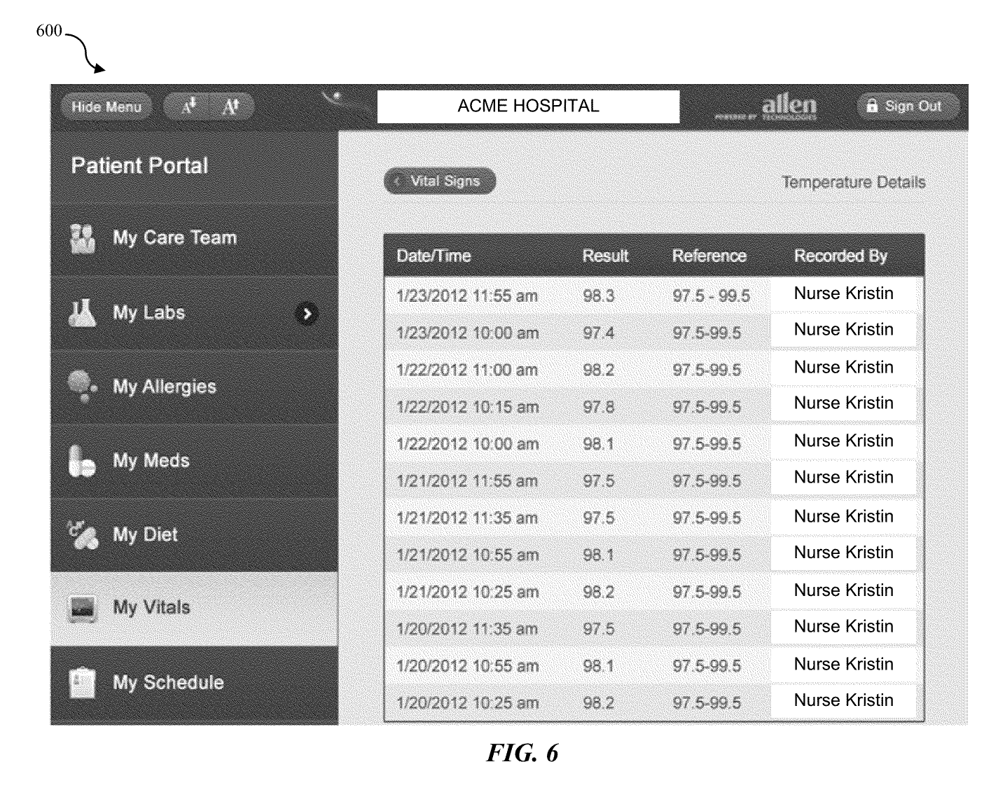

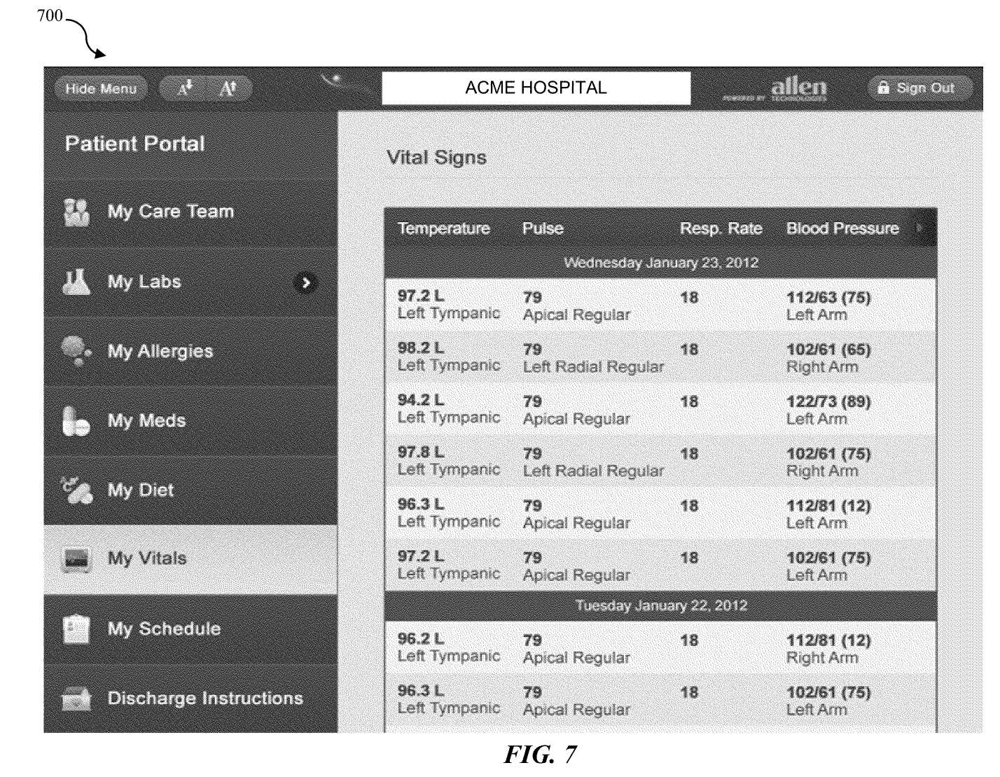

FIGS. 5, 6, and 7 show other exemplary screenshots 500, 600, and 700, respectively, illustrating example implementations of the present systems and methods. Selecting a vitals section from a patient info menu (e.g., “My Vitals”) may present the data from the patient's vitals that include temperature, blood pressure, pulse rate, blood oxygen saturation, etc. Vitals may be collected from the patients at several occasions during a day. The user interface may report the vitals for the entire current stay of the patient. The data may be displayed in the chart and graphical format. My Vitals data may include date (date taken), time, temperature, temperature source, blood pressure, blood pressure location, pulse, oxygen saturation, etc. My Vitals data may be retrieved from the management system as an XML snippet.

Selecting a medication section from a patient info menu (e.g., “My Medications”) may display information about Patient medications. It may contain drug name, description and link to details about the drug among other things. Description of drug may be obtained from a database that may be maintained separately. The data in the My Medications section may include marketing name, scientific name, generic name, dose, directions, doctor's signature, schedule, refills, etc. This section may be divided into two subsections, including hospitals medications and home medications. The subsection may display Patient medications while in the Hospital. The hospital medications subsection may be categorized further into current medications the patent takes on his or her own, discontinued medications, administered medications that are administered by hospital staff, including historical data of past medications and administrations. The home medications subsection may display medications that patient takes while at home. It has two subsections, including at home medications (e.g., medications that patient was on when admitted to the hospital) and discharge medications (e.g., medications that patient may be on after discharge from hospital). Medication data may be retrieved in XML snippets.

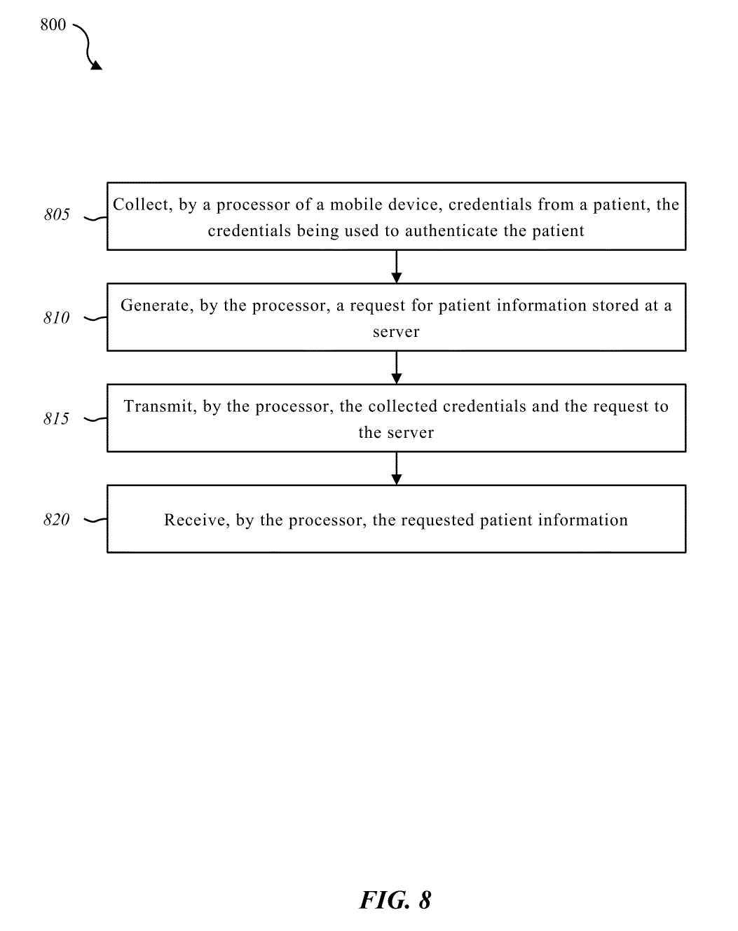

FIG. 8 is a flow diagram illustrating one embodiment of a method 800 for displaying information to a patient in a hospital setting. In some configurations, the method 800 may be implemented by the data module 125 illustrated in FIGS. 1 and/or 2. In some configurations, the method 800 may be implemented by the application 145 illustrated in FIG. 1.

At block 805, a mobile device collects credentials from a patient, the credentials being used to authenticate the patient. At block 810, a request for patient information stored at a server may be generated. At block 815, collected credentials and the request may be transmitted to the server. At block 820, the requested patient information may be received by the mobile device. Accordingly, a computing system may be configured to receive and display patient information to a patient in a hospital as well as allow the patient to control user entertainment devices including, but in no way limited to, audio visual systems, patient beds, and the like.

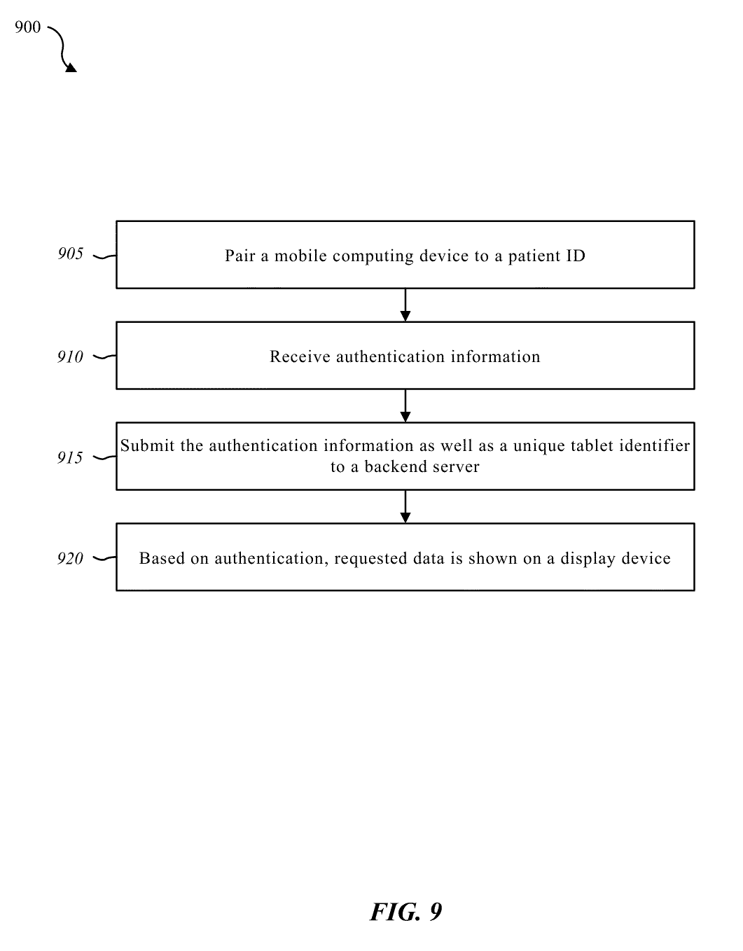

FIG. 9 is a flow diagram illustrating one embodiment of a method 900 for authenticating a patient to allow the patient to retrieve patient data. In some configurations, the method 900 may be implemented by the data module 125 illustrated in FIGS. 1 and/or 2. In some configurations, the method 900 may be implemented by the application 145 illustrated in FIG. 1.

At block 905, a tablet may be paired to a patient identifier. Additionally, or alternatively, the tablet may be paired with a patient's room and/or a device in the patient's room such as a television, a set-top box (STB), etc. At block 910, the tablet may be configured to receive authentication information. The authentication information may be received from the user entering data manually on a screen of the tablet, by the user speaking the information and the tablet receiving the data through a microphone. Additionally, or alternatively, the tablet may receive the data via a camera on the tablet capturing an image of a barcode on the patient's wristband and the tablet decoding the barcode, an RFID/NFC reader on the tablet receiving information from an RFID/NFC transmitter that transmits at least a portion of the authentication data, wirelessly from another device transmitting the data to the tablet, and the like. The authentication information may include a unique hospital-provided patient identifier (e.g., included on the patient's wristband), and a unique patient-provided identifier (e.g., the last 4 digits of the patient's SSN). At block 915, the tablet may submit the authentication information as well as a unique tablet identifier (e.g., MAC address of the tablet) to a backend server (e.g., apache/php server). The backend server may make a web service call to a tomcat server for authentication. The tomcat server may locate installed STB information based on the unique tablet ID. The tomcat server may verify the hospital-provided patient identifier based on the installed STB. The tomcat server may validate that the account ID associated with the STB is the same as that sent (authentication information) by the tablet. The tomcat server may pull the patient information from the XML data file based on account ID and validate the SSN last four digits. Once verified, the tomcat server may send a verified message or an error message stating the reason for not being able to validate the patient. If verified, the patient information may be stored in a session object on apache/php server until session expires. Accordingly, at block 920 data requested by the patient may be served to the installed STB. When seeking data, the backend server may send in a lastUpdate timestamp for data, if patient session is still authenticated. The tomcat server may respond notifying the backend server if there is an update available. If an update is available, the backend server may ask for new data from tomcat server and update its own session with the new data. The backend server may maintain authentication information for the patient and make sure that authentication information is still valid on a regular basis. Thus, the system may receive a unique hospital-provided patient ID, a unique tablet ID, and a unique user-provided ID in order to authenticate the patient and grant access to predetermined information from the backend.

In some embodiments, a tablet may be registered in the system using a web service. Webservice may receive key tablet information from the administrator and save tablet information in the database. A tablet may be paired to a room/bed via installed STB as a proxy. Since an installed STB has all patient related information, like account ID, IP address, switch port information, room, bed etc., the installed STB may be used as a proxy for room and bed pairing with the tablet. An administrator may be able to pair a tablet to a room and bed combination, which means that backend system may search for an installed STB associated with a room/bed combination and associate that installed STB with the tablet. An administrator may be able to pair the tablet from a native application on the tablet.

A getCurrentPairings webservice may return a JSON object with list of data objects containing location(room/bed), STB IP address and tablet ID. The tomcat server may get a list of all enabled Installed STBs for a given hospital. If a tablet is not paired to an installed STB, it may show up as null. A getPairingOfLocation webservice may return a tablet Id and IP address of the installed STB for a given location (i.e., bed and room combination). A getPairingOfATablet webservice may return location and IP address of the installed STB for a given tablet UUID. A setPairing webservice may pair a location, tablet, patient, room, bed, hospital wing, etc.

FIG. 12 depicts a block diagram of a computer system 1200 suitable for implementing the present systems and methods. The depicted computer system 1200 may be one example of a server 206 depicted in FIG. 2. Alternatively, the system 1200 may be one example of a device 105 depicted in FIGS. 1 and/or 2. Computer system 1200 includes a bus 1202 which interconnects major subsystems of computer system 1200, such as a central processor 1204, a system memory 1206 (typically RAM, but which may also include ROM, flash RAM, or the like), an input/output controller 1208, an external audio device, such as a speaker system 1210 via an audio output interface 1212, an external device, such as a display screen 1214 via display adapter 1216, serial ports 1218 and mouse 1246, a keyboard 1222 (interfaced with a keyboard controller 1224), multiple USB devices 1226 (interfaced with a USB controller 1228), a storage interface 1230, a host bus adapter (HBA) interface card 1236A operative to connect with a Fibre Channel network 1238, a host bus adapter (HBA) interface card 1236B operative to connect to a SCSI bus 1240, and an optical disk drive 1242 operative to receive an optical disk 1244. Also included are a mouse 1246 (or other point-and-click device, coupled to bus 1202 via serial port 1218), a modem 1248 (coupled to bus 1202 via serial port 1220), and a network interface 1250 (coupled directly to bus 1202).

Bus 1202 allows data communication between central processor 1204 and system memory 1206, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a data module 125-b to implement the present systems and methods may be stored within the system memory 1206. The data module 125-b may be one example of the data module 125 depicted in FIGS. 1, 2, and/or 3. Applications resident with computer system 1200 are generally stored on and accessed via a non-transitory computer readable medium, such as a hard disk drive (e.g., fixed disk 1252), an optical drive (e.g., optical drive 1242), or other storage medium. Additionally, applications can be in the form of electronic signals modulated in accordance with the application and data communication technology when accessed via network modem 1248 or interface 1250.

Storage interface 1230, as with the other storage interfaces of computer system 1200, can connect to a standard computer readable medium for storage and/or retrieval of information, such as a fixed disk drive 1252. Fixed disk drive 1252 may be a part of computer system 1200 or may be separate and accessed through other interface systems. Modem 1248 may provide a direct connection to a remote server via a telephone link or to the Internet via an internet service provider (ISP). Network interface 1250 may provide a direct connection to a remote server via a direct network link to the Internet via a POP (point of presence). Network interface 1250 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 12 need not be present to practice the present systems and methods. The devices and subsystems can be interconnected in different ways from that shown in FIG. 12. The operation of at least some of the computer system 1200 such as that shown in FIG. 12 is readily known in the art and is not discussed in detail in this application. Code to implement the present disclosure can be stored in a non-transitory computer-readable medium such as one or more of system memory 1206, fixed disk 1252, or optical disk 1244. The operating system provided on computer system 1200 may be MS-DOS®, MS-WINDOWS®, OS/2®, UNIX®, Linux®, or another known operating system.

Moreover, regarding the signals described herein, those skilled in the art may recognize that a signal may be directly transmitted from a first block to a second block, or a signal may be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there may inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A computer-implemented method to display information to a patient in a hospital setting, the method comprising:
collecting, by a processor of a mobile device;
generating, by the processor, a request for a server to authenticate the patient based on the credentials collected from the patient, and upon authenticating the patient, to reply with patient information requested by the patient;
transmitting, by the processor, the collected credentials and the request to the server;
receiving, by the processor, the requested patient information.

2. The method of claim 1, wherein the credentials include a hospital-provided patient identifier and a patient-provided identifier.

3. The method of claim 2, further comprising:
transmitting, to the server, a mobile device identifier associated with the mobile device together with the credentials and request, wherein the server sends the requested patient information to the mobile device upon authenticating the patient and verifying an association between the unique mobile device identifier, the request, and the credentials.

4. The method of claim 2, further comprising:
collecting the hospital-provided patient identifier by scanning an optical machine-readable code on a hospital-provided wristband using a camera on the mobile device.

5. The method of claim 2, further comprising:
collecting the hospital-provided patient identifier by scanning a hospital-provided radio-frequency identifier (RFID) device.

6. The method of claim 2, further comprising:
collecting the hospital-provided patient identifier by scanning a hospital-provided near-field communications (NFC) device.

7. The method of claim 3, wherein the mobile device identifier comprises a media access control (MAC) address of the mobile device.

8. The method of claim 1, further comprising:
prior to sending the request for patient information, verifying, via the credentials and a mobile device identifier associated with the mobile device, that the mobile device is assigned to the patient.

9. The method of claim 1, wherein the request further comprises a request to receive, in addition to the patient information, at least one instance of multimedia data associated with the patient from the server.

10. A computing device configured to display information to a patient in a hospital setting, the computer device comprising:
a processor;
memory in electronic communication with the processor;
instructions stored in the memory, the instructions being executable by the processor to:
collect credentials from the patient;
generate a request for a server to authenticate the patient based on the credentials collected from the patient, and upon authenticating the patient, to reply with patient information requested by the patient;
transmit the collected credentials and the request to the server;
receive the requested patient information.

11. The computing device of claim 10, wherein the credentials include a hospital-provided patient identifier and a patient-provided identifier.

12. The computing device of claim 11, the instructions are executable by the processor to:
transmit, to the server, a mobile device identifier associated with the mobile device together with the credentials and request, wherein the server sends the requested patient information to the mobile device upon authenticating the patient and verifying an association between the unique mobile device identifier, the request, and the credentials.

13. The computing device of claim 11, the instructions are executable by the processor to:
collect the hospital-provided patient identifier by scanning an optical machine-readable code on a hospital-provided wristband using a camera on the mobile device.

14. The computing device of claim 11, the instructions are executable by the processor to:
collect the hospital-provided patient identifier by scanning a hospital-provided radio-frequency identifier (RFID) device.

15. The computing device of claim 11, the instructions are executable by the processor to:
collect the hospital-provided patient identifier by scanning a hospital-provided near-field communications (NFC) device.

16. The computing device of claim 11, the mobile device identifier comprises a media access control (MAC) address of the mobile device.

17. The computing device of claim 11, the instructions are executable by the processor to:
prior to sending the request for patient information, verify, via the credentials and a mobile device identifier associated with the mobile device, that the mobile device is assigned to the patient.

18. The computing device of claim 11, wherein the request further comprises a request to receive, in addition to the patient information, at least one of audio and media data from the server.

19. A computer-program product for displaying information to a patient in a hospital setting, by a processor, content on a screen, the computer-program product comprising a non-transitory computer-readable medium storing instructions thereon, the instructions being executable by the processor to:
collect credentials from the patient;
generate a request for a server to authenticate the patient based on the credentials collected from the patient, and upon authenticating the patient, to reply with patient information requested by the patient;
transmit the collected credentials and the request to the server;
receive the requested patient information.

20. The computer-program product of claim 19, wherein the instructions are executable by the processor to:
transmit, to the server, a mobile device identifier associated with the mobile device together with the credentials and request, wherein the credentials include a hospital-provided patient identifier and a patient-provided identifier, and wherein the server sends the requested patient information to the mobile device upon authenticating the patient and verifying an association between the unique mobile device identifier, the request, and the credentials.
